(19) United States
(12) Patent Application Publication
(10) Pub. No.: US 2026/0118879 A1
(43) Pub. Date: Apr. 30, 2026

(54) ROUTE SURVIVABILITY AUTONOMOUS METHOD AND SYSTEM FOR AN UNMANNED AIRCRAFT SYSTEM

(71) Applicant: ROCKWELL COLLINS, INC., Cedar Rapids, IA (US)

(72) Inventors: Alexander V. ROUP, Centreville, VA (US); Rebecca DEBSKI, Reston, VA (US)

(73) Assignee: ROCKWELL COLLINS, INC., Cedar Rapids, IA (US)

(21) Appl. No.: 18/931,378

(22) Filed: Oct. 30, 2024

(51) Int. Cl. G05D 1/617; G05D 1/646; G05D 101/15; G05D 109/20

(52) U.S. Cl. CPC G05D 1/619; G05D 1/646; G05D 2101/15; G05D 2109/20

(57) ABSTRACT

An unmanned aircraft system (UAS) may include a route survivability autonomous system to evade threats using a Markov Decision Process (MDP). A threat location along with other information is provided to a subsystem. A state helper function defines a state having state features, include a threat level severity of the threat. The state having the state features is provided to an MDP policy created for the UAS. The MDP policy determines an action for the UAS based on the state features. The action is provided to an action helper function to determine a guidance for the UAS. A maneuver primitive supervisor (MPS) issues a command for the UAS to evade the threat or continue the route based on the guidance.

### FIELD OF THE INVENTION

The subject matter disclosed herein relates to the implementation of a system and method for guidance action selection in an unmanned aircraft system (UAS). In particular, the subject matter relates to systems and methods that are used to implement autonomy policies that can be flexibly re-designed.

### BACKGROUND OF THE INVENTION

Autonomy systems employ decision policies that are easily updatable in response to changes in system parameters for a UAS and its applicable environment. Decision making occurs based upon abstracted representations of observable world states that may complicate direct design of policies.

### SUMMARY OF THE INVENTION

The present disclosure is directed, in a first aspect, to a route survivability autonomous system for an unmanned aircraft system (UAS). The route survivability autonomous system includes a subsystem configured to execute a state helper function to define a state having state features for the UAS. The subsystem receives a threat location relative to the UAS and generates a threat severity level as a state feature for the state. The route survivability autonomous system also includes a Markov Decision Process (MDP) policy configured to receive the state having the state features for the UAS and to determine an action. The route survivability autonomous system also includes a maneuver primitive (MP) helper to execute an action helper function based on the action determined by the MDP policy. The action helper function defines a guidance for the UAS based on the action. The route survivability autonomous system also includes a maneuver primitive supervisor (MPS) configured to receive the guidance based on the action from the MDP policy and to issue a command to the UAS.

In yet another embodiment, the present disclosure is directed to a method for operating an unmanned aircraft system (UAS) to evade a threat. The method includes receiving a threat location of the threat at a state helper function of a subsystem for a route survivability autonomous system for the UAS. The method also includes generating a state having state features using the state helper function. The method also includes determining an action for the UAS using a Markov Decision Process (MDP) policy. The method also includes defining a guidance for the UAS using an action helper function based on the action from the MDP policy. The method also includes issuing a command to the UAS based on the guidance in response to the threat.

In yet another embodiment, the present disclosure is directed to a method for generating a Markov Decision Process (MDP) policy for use in a route survivability autonomous system for an unmanned aircraft system (UAS). The method includes defining a set of finite states for the UAS. The method also includes defining a set of actions for the UAS corresponding to the set of finite states. The method also includes defining a transition function using a first helper function to generate a probability tensor. The method also includes defining a reward function using a second helper function to generate a reward sensor. The method also includes using a MDP solver to generate the MDP policy based on the set of finite states, the set of actions, the probability tensor, and the reward tensor.

### BRIEF DESCRIPTION OF FIGURES

The features of the disclosure believed to be novel and the elements characteristic of the invention are set forth with particularity in the appended claims. The figures are for illustration purposes only and are not drawn to scale. The disclosure itself, however, both as to organization and method of operation, can best be understood by reference to the description of the preferred embodiment(s) which follows, taken in conjunction with the accompanying drawings in which:

FIG. 1 illustrates a block diagram of a system for a UAS according to the disclosed embodiments.

FIG. 2 illustrates a route survivability autonomy system that implements an MDP process within the UAS according to the disclosed embodiments.

FIG. 3 illustrates a flow diagram for generating an MDP policy according to the disclosed embodiments.

FIG. 4 illustrates a flow diagram for online policy execution within the UAS according to the disclosed embodiments.

### DETAILED DESCRIPTION OF THE INVENTION

The embodiments of the present disclosure can comprise, consist of, and consist essentially of the features and/or steps described herein, as well as any of the additional or optional ingredients, components, steps, or limitations described herein or would otherwise be appreciated by one of skill in the art.

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. In the following detailed description of the embodiments of the inventive concepts, numerous specific details are set forth in order to provide a more thorough understanding of the inventive concepts. It will be apparent to one skilled in the art, however, having the benefit of the instant disclosure that the inventive concepts disclosed herein may be practiced without these specific details.

As used herein, a letter following a reference numeral is intended to reference an embodiment of the feature or element that may be similar, but not necessarily identical, to a previously described element or feature bearing the same reference numeral, such as 1, 1a, or 1b. Such shorthand notations are used for purposes of convenience only, and should not be construed to limit the inventive concepts disclosed herein in any way unless expressly stated to the contrary.

Moreover, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of embodiments of the instant inventive concepts. This is done merely for convenience and to give a general sense of the inventive concepts, and “a” and “an” are intended to include one or at least one and the singular also includes plural unless it is obvious that it is meant otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, and/or groups thereof.

As used herein, any reference to “one embodiment,” “alternative embodiments,” or “some embodiments” means that particular element, feature, structure, or characteristic described in connection with the embodiment is included in at least one embodiment of the inventive concepts disclosed herein. The appearances of the phrase “in some embodiments” in various places in the specification are not necessarily all referring to the same embodiment, and embodiments of the inventive concepts disclosed may include one or more of the features expressly described or inherently present herein, or any combination or sub-combination of two or more such features, along with any other features that may not necessarily be expressly described or inherently present in the instant disclosure.

The inventive concepts may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

Inventive concepts may be implemented as a computer process, a computing system or as an article of manufacture such as a computer program product of computer readable media. The computer program product may be a computer storage medium readable by a computer system and encoding computer program instructions for executing a computer process. When accessed, the instructions cause a processor to enable other components to perform the functions disclosed below.

The present disclosure is directed to an autonomy policy design method using a Markov Decision Process formulation focused on a decision scenario applicable to UAS flying at low altitude. The disclosed embodiments select a state and action set, and implemented state calculation and action execution helper functions. The disclosed embodiments implement a set of functions that calculate state transition probabilities and rewards for the particular problem, using a reduced order set of parameters to enable the user to tune the policy design to satisfy verification rules. The method may be used to implement autonomy policies that can be flexibly re-designed in response to changes in the system or its environment. The disclosed policy design process may use a reduced order parameter set.

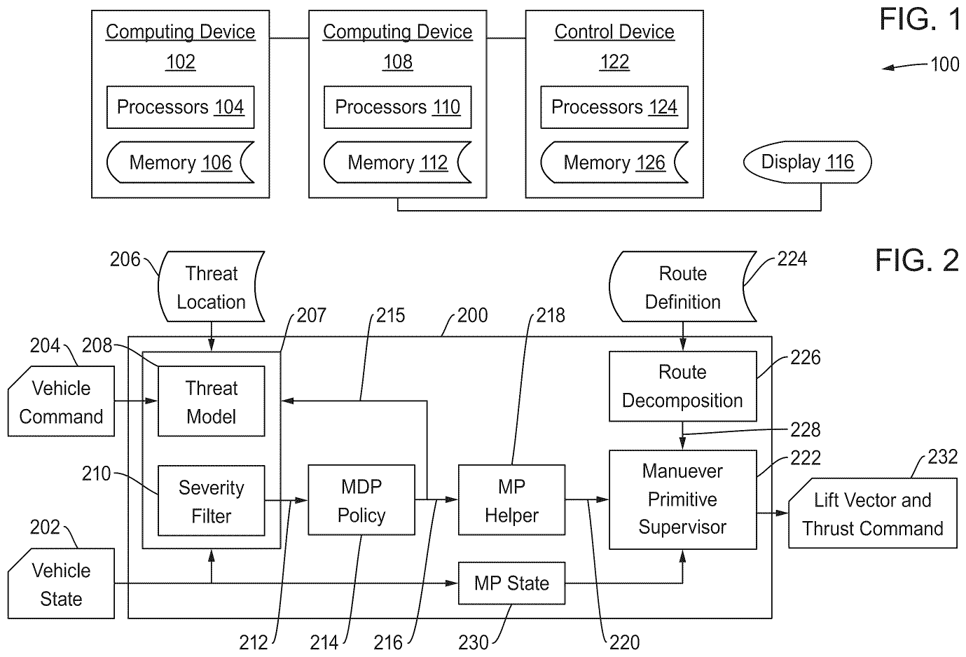

FIG. 1 depicts a block diagram of a system 100 according to the disclosed embodiments. System 100 may include an UAS or unmanned aerial vehicle (UAV). The disclosed embodiments will refer to UAS for brevity. System 100 includes at least one computing device 102, at least one computing device 108, and a control device 122 configured to provide flights plans for the aircraft of system 100. In some embodiments, any or all of computing device 102, computing device 108, and control device 122 may be installed onboard the UAS. In other embodiments, some of computing device 102, computing device 108, and control device 122 may be installed off-board of the UAS.

Computing device 102 may be implemented as any suitable computing device. Computing device 102 may include at least one processor 104, at least one memory 106, or at least one storage, some or all of which may be communicatively coupled at any given time. For example, processor 104 may include at least one central processing unit (CPU), at least one graphics processing unit (GPU), at least one field-programmable gate array (FPGA), at least one application specific integrated circuit (ASIC), at least one digital signal processor, at least one deep learning processor unit (DPU), at least one virtual machine (VM) running on at least one processor, and the like configured to perform any of the operations disclosed herein.

For example, processor 104 may include a CPU and a GPU configured to perform the operations disclosed herein. Processor 104 may be configured to run various software applications or computer code stored, or maintained, in a non-transitory computer-readable medium such as memory 106 and configured to execute various instructions or operations. For example, processor 104 of computing device 102 may be configured to obtain relevant historical data of filed flight paths, air traffic, and actual flight paths taken by the UAS, or train a model to identify an optimal direction from a given cell at a point along a re-route. In some embodiments, the trained model is trained based at least on real-world samples of filed paths as compared to actual paths taken by sampled aircraft.

Computing device 108 may be implemented as any suitable computing device, such as a path re-router or a flight management system. Computing device 108 may include at least one processor 110, at least one memory 112, or at least one storage, some or all of which may be communicatively coupled at any given time. For example, processor 110 may include at least one central processing unit (CPU), at least one graphics processing unit (GPU), at least one field-programmable gate array (FPGA), at least one application specific integrated circuit (ASIC), at least one digital signal processor, at least one deep learning processor unit (DPU), at least one virtual machine (VM) running on at least one processor, or the like configured to perform any of the operations disclosed herein.

For example, processor 110 may include a CPU and a GPU configured to perform the operations disclosed herein. Processor 110 may be configured to run various software applications or computer code stored, or maintained, in a non-transitory computer-readable medium such as memory 112 and configured to execute various instructions or operations. For example, processor 110 of computing device 108 may be configured to (a) obtain parameters including at least one of flight parameters associated with the UAS, weather parameters, special use airspace parameters, or air traffic parameters; (b) based on at least the parameters, update flight-state data associated with the UAS; (c) obtain a trained model, such as from computing device 102; (d) based on at least the updated flight-state data and the trained model, infer a direction from a current cell; (e) based on the inferred direction and the updated flight-state data, set the current cell and identify the neighboring cells neighboring both (1) the current cell and (2) the inferred direction; (f) calculate an optimal next cell by using a shortest path finding (SPF) algorithm to select the optimal next cell from the neighboring cells; (g) iteratively repeat at least steps (d) through (f) such that the current cell is set as the optimal next cell until a goal state is reached; (h) construct a re-route using optimal cells iteratively calculated in step (f); or (i) output the re-route. In some embodiments, processor 110 is further configured to base at least on the inferred direction and the updated flight-state data, set the current cell, identify the neighboring cells neighboring both (1) the current cell and (2) the inferred direction, and disable non-neighboring cells.

Control device 122 may include at least one processor 124, at least one memory 126, or at least one storage, some or all of which may be communicatively coupled at any given time. For example, processor 124 may include at least one central processing unit (CPU), at least one graphics processing unit (GPU), at least one field-programmable gate array (FPGA), at least one application specific integrated circuit (ASIC), at least one digital signal processor, at least one deep learning processor unit (DPU), at least one virtual machine (VM) running on at least one processor, or the like configured to perform any of the operations disclosed herein.

For example, processor 124 may include a CPU and a GPU configured to perform any of the operations disclosed herein. Processor 124 may be configured to run various software applications or computer code stored, or maintained, in a non-transitory computer-readable medium such as memory 126 and configured to execute various instructions or operations. For example, processor 124 may be configured to receive the re-route, such as from computing device 108, or output graphical data associated with the re-route to a display 116.

In some embodiments, computing device 108 may implement various algorithms for the UAS of system 100. The smaller scale of operation and flight times related to a UAS mean that the operations tempo will be faster, where re-routing decisions should be made quickly and without error. The UAS typically will be closer to the ground or at low altitudes compared to piloted aircraft. The UAS also will engage with threats from the ground and low altitude hazards, such as birds, clouds, rain, buildings, and the like.

Further, like other embedded environments, thermal, power, and size constraints of the UAS platform may limit the hardware selected. In computing hardware, this limit may be appreciated by requiring low power processors that are slower then desktop class processor. In some instances, the hardware selected for system 100 and implemented by computing devices 102 and 108 are not selected for being high-performing but that the hardware fits within the size, weight, and power (SWAP) constraints of the UAS. This feature may result in algorithms running slower on a UAS than on embedded hardware.

Computing device 108, therefore, may implement algorithms that are effective for these problems to navigate while avoiding collisions with other aircraft and obstacles while also remaining efficient enough to run on lower-powered, light weight embedded computing hardware used in avionics with limited processing, memory, and storage capability. Markov Decision Processes (MDP) may be implemented within system 100. MDPs may be a framework for sequential decision making.

MDPs are formulated as the tuple (S, A, R, T) where sₜ ∈ S is the state at a given time t, at ∈ A as the action taken by the UAS at time t as a result of the decision process, rₜ ∈ R (Sₜ, aₜ, Sₜ₊₁) is the reward received by the UAS as a result of taking the action aₜ from sₜ, and arriving at sₜ₊₁, and T(Sₜ, aₜ, Sₜ₊₁) is a transition function that describes the dynamics of the environment and captures the probability p(Sₜ₊₁; Sₜ, aₜ) of transitioning to a state sₜ₊₁ given the action aₜ taken from state sₜ.

A policy n may be defined that maps each state s e S to an action a E A. From a given policy π ∈ Π, a value function V(s) may be computed that describes the expected future reward that may be obtained by the UAS by following the policy n. For a given MDP, a given value function may be unique but multiple policies may exist that result in the same value function. One problem with MDPs is that the size of the state space for S and the size of the action space for A may grow quickly.

FIG. 2 depicts a route survivability autonomy system 200 that implements a MDP process within the UAS according to the disclosed embodiments. System 200 may be configured within computing device 108 to provide the functionality of re-routing the UAS. One or more processors 110 may host system 200. In some embodiments, the MDP processes implemented within system 200 should be able to command an evasion function for the UAS. An objective for the UAS may be to stay hidden during operations. Other objectives include mission objectives and focus on risk tolerance.

System 200 may receive vehicle state 202 from other components or sensors within the UAS. Vehicle command 204 is an external command also received along with threat location 206. Threat location 206 may be a detected threat to the UAS as determined by other components within the UAS, such as computing device 102.

Vehicle state 202, vehicle command 204, and threat location 206 may be received at subsystem 207, which includes threat model 208 and severity filter 210. Threat model 208 may determine how dangerous is the threat at threat location 206. The threat is classified at a threat level. The threat level is used for state information, disclosed below. Severity filter 210 may classify if the threat is getting better or worse. For example, severity filter 210 may take into account how long has the UAS been exposed to the threat. If threat is getting better, such as it is running away, then maybe the UAS does not take action. Threat model 208 and severity filter 210 takes the received data into account to generate MDP state 212.

MDP state 212 is received by MDP policy 214. MDP policy 214 may act as one or more policies for use in the MDP process disclosed above. MDP policy 214 is applied to MDP state 212 to determine action 216. MDP policy 214 may be a function or model that is trained to determine an action based on MDP state 212.

MDP state 212 may include state features that are fed into MDP policy 214. State features may include vehicle command, threat severity, previous action, and dead. The vehicle command state feature may come from vehicle command 204. The UAS may have a command to observe and perform data collection. Alternatively, it may have a command to evade and prioritize survivability. The threat severity state feature may reflect the threat level. Level 1 may be nominal, level 2 may be detected, level 3 may be warning, and level 4 may be an emergency.

Other state features include previous action, such as continue on route, fly at a low altitude route, perform a shallow turn, or perform a maximum turn. The dead state feature may be false or true. False is the state of living to fight another iteration. Dead is a terminal state, or game over for the UAS.

MDP policy 214 may receive data in the above state features and determines an action 216. Previous action 215 also may be generated based on the determined action and provided back to subsystem 207. Action 216 may be the action to be taken by the UAS. One action may be route which executes the route segment maneuver primitives (MP) with route parameters from the mission plan for the UAS. Another action may a low altitude route which executes the planned route, but drops to a very low altitude. In some embodiments, the UAS may use terrain following maneuver primitives. Another action may be a shallow turn which executes a shallow lateral offset that turns away from the threat at threat location 206, and also may be terrain following. Another action may be a maximum turn that executes a maximum lateral offset turn away from the threat and also may be terrain following.

Action 216 is provided to MP helper 218. MP helper 218 may be a helper function within system 200. MP helper 218 transforms actions into guidance. MP helper 218 generates MP command 220 that is provided to route survivability maneuver primitive supervisor (MPS) 222. MPS 222 generates lift vector and thrust command 232 to the UAS. Lift vector and thrust commands may be at a lower level of abstraction that turn or altitude commands. A lift vector command may command the bank altitude angle of the UAS and the normal acceleration. The thrust command part may command propulsion thrust force. Thus, lift vector and thrust may be at a higher level of abstraction than stick inputs, but at a lower level of abstraction than commanding a turn or change in altitude, which may be path guidance type of commands.

Command 232 may be sent to computing device 102 to re-route or maintain the route of the UAS. MPS 222 also receives data from MP state 230, which is related to vehicle state 202. Route definition 224 also may be considered by MPS 222. Route definition 224 is provided to route decomposition 226 which generates decomposed route definition 228 and provide this information to MPS 222.

Thus, system 200 receives information about a possible threat, including threat location 206, as well as information about the UAS in the form of vehicle command 204, vehicle state 202, and route definition 224 to generate lift vector and thrust command 232 to evade the possible threat. System 200 uses MDP policy 214 that implements a MDP process to determine an action 216 to be taken by the UAS based on MDP state 212.

The disclosed embodiments define MDP policy 214 also using helper functions. These helper functions may be used to calculate a probability tensor and to calculate a reward tensor. Helper functions also may be used in defining states to input into MDP policy 214 and to transform actions into guidance. The helper functions implemented by the disclosed embodiments are set forth in greater detail below.

FIG. 3 depicts a flow diagram 300 for offline policy design for generating MDP policy 214 according to the disclosed embodiments. MDP solver 312 may be a tool to generate MDP policy 214 using states 304, actions 306, transition function 308, and reward function 310. States 304 may be a finite set of states for use in the MDP process. Example states 304 are disclosed above. Actions 306 may be a finite set of actions that can be performed by the UAS. Transition function 308 may be a transition model. Reward function 310 may include a lookup table.

Expert input 302 may be used to define states 304 and actions 306. As disclosed above, states 304 may include state features of a vehicle command, a threat severity, a previous action, and a dead condition. The state features may be expanded as disclosed above. For example, the vehicle command state feature may include observe or evade. Actions 306 may include follow route, follow the route at a low altitude, perform a shallow turn, and perform a maximum turn.

Transition function 308 may be generated using helper function 314, or fₚ. Helper function 314 calculates a probability tensor for transition function 308. Reward function 316 may be generated using helper function 316, or f_{R}. Helper function 316 calculates a reward tensor for reward function 310. Helper functions 314 and 316 may implement tensor design functions 318. Tensors may have a very large dimensionality. Helper functions 314 and 316 make the policy design problem tractable. A tensor may be a matrix. It may be multi-dimensional with a list of coordinates for different state features. The tensor may be listed on one axis. It may provide a summary of parameterizations.

The disclosed embodiments construct the probability and reward tensors for policy generation. The inputs into helper functions 314 and 316 may be the number of states and number of actions. The output of the helper functions are probability and reward tensors. A probability tensor shows the probability of transitioning between a current given state and a given future state, assuming an action is taken. Different probability tensors may be defined for different actions. A reward tensor shows the reward obtained by transitioning between a given current state and a given future state, assuming an action is taken.

Tensor design functions 318 may include design parameters for the states based on the state features. The disclosed embodiments allow for the use of fewer design parameters than the full number of entries in tensors using superposition. The disclosed embodiments define probabilities and rewards for subspaces of the full dimensionality of the respective probability tensor and reward tensor and then combines the tensors to produce the full tensor. This process relies on the independence between these subspaces. This feature makes larger dimensionality problems tractable.

For example, the design parameters for tensor design functions 318 may have 106 values, which are then used by helper functions 314 and 316 to input into transition function 308, which may have 4356 values, and reward function 310, which also may have 4356 values. These large number of values may be due to the large number of states and actions that are applicable to the UAS. These values are provided to MDP solver 312, which generates policy 214. Policy 214 may have 33 values.

In some embodiments, independent reward contributors for the following reward sources may be summed to produce the final tensor. The reward source may incentivize observation, incentivize evasion, penalize skipping progressive action jumps, such as if a previous action was 1, then the next action should be 1 or 2 rather than skipping directly to 3, reward for following the route, penalize action changes to avoid dithering back and forth between two action choices, reward for non-active threat states to incentivize reaching a state where the threat is not present, penalize for unsuccessful evasion, and the like.

Similarly, the probability tensor may be developed through superposition of subspaces within the tensor. For probability, these may follow the state feature types, so contributions for threat severity, vehicle command, and previous action are assigned independently.

MDP solver 312 may define the MDP to be implemented within system 200. MDP solver 312 may find the optimal policies based on states 304, actions 306, transition function 308, and reward function 310. MDP solver 312 may seek to maximize rewards over time. MDP solver 312 may implement algorithms like value iteration, policy iteration, or linear programming to compute policy 214.

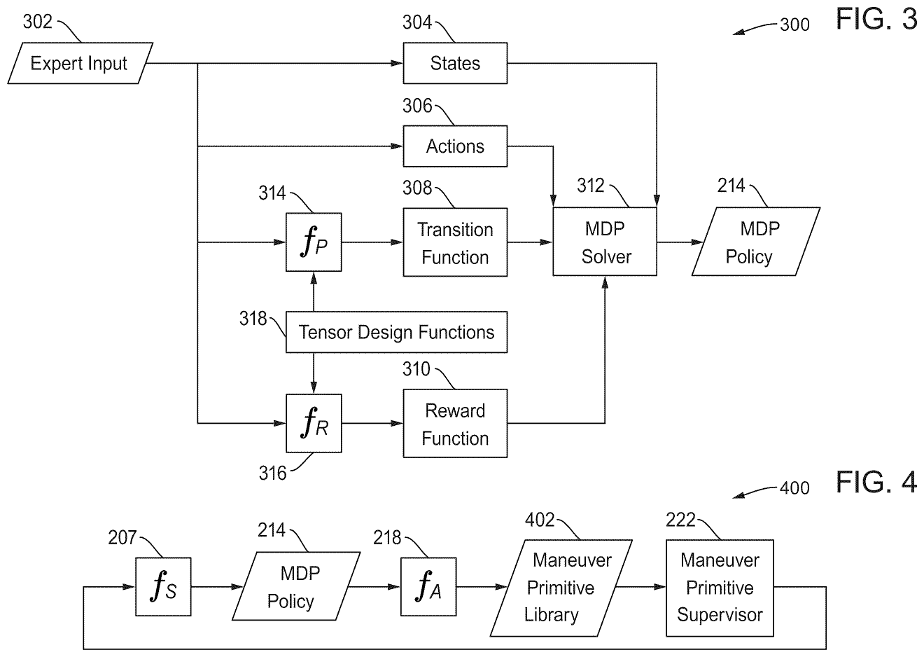

FIG. 4 depicts a flow diagram 400 for online policy execution within the UAS according to the disclosed embodiments. MDP policy 214, after being created using the embodiments disclosed by flow diagram 300, may be placed within system 200 to provide an action 216 to MP helper 218. MDP policy 214 also may receive MDP state 212 from subsystem 207. In some embodiments, subsystem 207 implements a helper function f_{S} and MP helper implements a helper function f_{A}.

Helper function f_{S} may be used to construct discrete state values. In some embodiments, the UAS of system 100 may be maneuvering near threats at a low altitude. This helper function takes inputs of the kinematic state of the UAS, such as position, velocity, and acceleration, the threat location, and the action that been selected on the previous iteration, as shown in FIG. 2. Helper function f_{S} may use a threat probability model and a threat-relative velocity to classify the threat severity (TS) of the UAS. Threat severity may be one of the state features.

In some embodiments, the threat probability model may be used to define and quantify a threat dome for a ground-based threat. Inputs may include relative position, minimum radius, minimum probability, scale factor, minimum elevation, minimum horizontal radius, and the like. The output may be the instantaneous threat probability, as captured by the threat severity state feature.

Helper function f_{A} may be used to transform actions into guidance. As disclosed above, there may be four actions taken by the UAS and defined by this helper function. One action may be to follow the route. UAS may be kept in autopilot mode that follows a defined route between planned waypoints as provided by route definition 224. Another action is to follow the route at a low altitude, which is similar to the action above but the UAS is flying in Above Ground Level (AGL) vertical mode, with the altitude command at a minimum value. In the horizontal axis, the UAS is still following the original planned route. This mode is intended to get the UAS below the minimum elevation angle of a threat and potentially utilize terrain masking.

Another action defined by this helper function may be a shallow turn. The helper function may generate a lateral offset to the planned route that pushes the UAS away from the direction of the threat. The UAS still proceeds along the planned route and only offset up to lateral limits. One consideration is to limit the lateral offset so that it could not bring the UAS in proximity with surrounding terrain. The disclosed embodiments may continuously evaluate the local slope and curvature of surrounding ground elevations to determine a safe limit. For the shallow turn action, the offset is increased gradually as the UAS approached the threat location. For shallow turn, the vertical guidance is altitude following the minimum AGL disclosed above.

Another action maybe a maximum turn. This action employs a more significant offset from the planned route that the shallow turn. This action uses similar processes to the shallow turn but goes to the maximum offset allowable for the UAS. A possible action may be a maximum performance turn. This action turns the vehicle away from the threat at the limits of its performance envelope. This feature may use one of the maneuver primitives from a relative maneuvering guidance function library 402.

MP helper 218 may interact with maneuver primitive library 402. The output of MP helper 218 is provided to MPS 222, which outputs command 232 to route the UAS. Command 232 may include evasive action in response to the threat at threat location 206. MDP policy 214 may be implemented in system 200 using the helper functions to interface the policy into the autonomous system for the UAS.

While the present disclosure has been particularly described, in conjunction with specific preferred embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the present disclosure.

What is claimed is:

1. A route survivability autonomous system for an unmanned aircraft system (UAS) comprising:
a subsystem configured to execute a state helper function to define a state having state features for the UAS, wherein the subsystem receives a threat location relative to the UAS and generates a threat severity level as a state feature for the state;
a Markov Decision Process (MDP) policy configured to receive the state having the state features for the UAS and to determine an action;
a maneuver primitive (MP) helper to execute an action helper function based on the action determined by the MDP policy, wherein the action helper function defines a guidance for the UAS based on the action; and
a maneuver primitive supervisor (MPS) configured to receive the guidance based on the action from the MDP policy and to issue a command to the UAS.

2. The route survivability autonomous system of claim 1, wherein the state features include a vehicle command to observe or to evade.

3. The route survivability autonomous system of claim 1, wherein the state features include a previous action determine by the MDP policy.

4. The route survivability autonomous system of claim 1, wherein the state features include a dead condition.

5. The route survivability autonomous system of claim 1, wherein the guidance includes a follow route action for the UAS.

6. The route survivability autonomous system of claim 1, wherein the guidance includes a follow route at a low altitude action for the UAS.

7. The route survivability autonomous system of claim 1, wherein the guidance includes a shallow turn action for the UAS.

8. The route survivability autonomous system of claim 1, wherein the guidance includes a maximum turn action for the UAS.

9. The route survivability autonomous system of claim 1, wherein the command issued by the MPS is a lift vector and thrust command.

10. The route survivability autonomous system of claim 1, wherein the subsystem includes a threat model to execute the state helper function.

11. The route survivability autonomous system of claim 1, wherein the subsystem includes a severity filter.

12. A method for operating an unmanned aircraft system (UAS) to evade a threat, the method comprising:
receiving a threat location of the threat at a state helper function of a subsystem for a route survivability autonomous system for the UAS;
generating a state having state features using the state helper function;
determining an action for the UAS using a Markov Decision Process (MDP) policy;
defining a guidance for the UAS using an action helper function based on the action from the MDP policy; and
issuing a command to the UAS based on the guidance in response to the threat.

13. The method of claim 12, further comprising determining a threat severity level using the state helper function for the state features.

14. The method of claim 12, wherein the state features of the state include a vehicle command.

15. The method of claim 12, wherein the state features of the state include a dead condition.

16. The method of claim 12, wherein the guidance includes a follow route action for the UAS.

17. The method of claim 12, wherein the guidance includes a follow route action at a low altitude action for the UAS.

18. The method of claim 12, wherein the guidance includes a shallow turn action for the UAS.

19. The method of claim 12, wherein the guidance includes a maximum turn action for the UAS.

20. A method for generating a Markov Decision Process (MDP) policy for use in a route survivability autonomous system for an unmanned aircraft system (UAS), the method comprising:
defining a set of finite states for the UAS;
defining a set of actions for the UAS corresponding to the set of finite states;
defining a transition function using a first helper function to generate a probability tensor;
defining a reward function using a second helper function to generate a reward tensor; and
using a MDP solver to generate the MDP policy based on the set of finite states, the set of actions, the probability tensor, and the reward tensor.
